(19) United States
(12) Patent Application Publication
(10) Pub. No.: US 2020/0156072 A1
(43) Pub. Date: May 21, 2020

(54) MICROFLUIDIC CHIP FOR SORTING SPERM AND SPERM SORTING METHOD

(71) Applicants: Bor-Ran LI, Hsinchu City (TW); Sheng-You GUO, Tainan City (TW); Chen-Yen CHUNG, New Taipei City (TW)

(72) Inventors: Bor-Ran LI, Hsinchu City (TW); Sheng-You GUO, Tainan City (TW); Chen-Yen CHUNG, New Taipei City (TW)

(21) Appl. No.: 16/559,641

(22) Filed: Sep. 4, 2019

Related U.S. Application Data
(60) Provisional application No. 62/768,113, filed on Nov. 16, 2018.

(30) Foreign Application Priority Data
Jun. 14, 2019 (TW) 108120783

(51) Int. Cl. B01L 3/00

(52) U.S. Cl. CPC B01L 3/502761; B01L 2200/0652; B01L 2300/0858; B01L 2300/0816

(57) ABSTRACT

A microfluidic chip for sorting sperm includes a substrate, a sample channel, and a plurality of divergent channels. The sample channel is disposed in the substrate. The divergent channels are disposed in the substrate. Each of the divergent channels includes a main channel and two branch channels. The two branch channels are connected to an end of the main channel away from the sample channel. The two branch channels are disposed at two sides of the main channels respectively. The sample channel and the main channels of the plurality of divergent channels are substantially connected to each other in serial along a direction.

### CROSS-REFERENCE TO RELATED APPLICATION

This application claims priority to U.S. Provisional Application Ser. No. 62/768,113, filed Nov. 16, 2018, and Taiwan Application Serial Number 108120783, filed Jun. 14, 2019, the disclosures of which are incorporated herein by reference in their entireties.

### BACKGROUND

### Field of Invention

The present invention relates to a microfluidic chip for sorting sperm and a sperm sorting method. More particularly, the present invention relates to the microfluidic chip for sorting activity levels of sperm and the method for sorting activity levels of the sperm.

### Description of Related Art

In recent years, infertility has become one of the most important issues in the medical field. According to the statics from the World Health Organization, about 10%-15% of couples are troubled by the infertility. Among these couples, 30% of the causes of the infertility are caused by male factors, and 20% are caused by both male and female factors. Therefore, how to obtain sperm with good quality from males is very important.

The ability to conceive is mainly determined by two factors which are the number of sperm and the activity of sperm. In the present, assisted reproductive technology (ART) can help some men solve infertility problems. The most two common methods are in vitro fertilization (IVF) and intracytoplasmic sperm injection (ICSI).

Among these ARTs, it is necessary to select sperm with high-quality and good activity form patient's semen first, and then let the selected sperm and the egg combine to realize the insemination. In the conventional techniques, methods for screening active sperm include a swim up method and a density gradient centrifugation method. After, screening active sperm, medical personnel have to further screen and evaluate the number and the activity of the selected sperm under a microscope.

However, the method mentioned above is not only time-consuming for medical personnel, but also unable to effectively screen out the sperm with good activity. What's worse, the above screening method may harm sperm and force the screening of sperm to be ineffective. Therefore, how to propose a microfluidic chip and a sorting method to solve the above problems becomes an important issue in the industry.

### SUMMARY

The invention provides a microfluidic chip and a method to effectively sort activity levels of sperm.

According to an embodiment of the disclosure, the microfluidic chip for sorting sperm includes a substrate, a sample channel, and a plurality of divergent channels. The sample channel is disposed in the substrate. The divergent channels are disposed in the substrate. Each of the divergent channels includes a main channel and two branch channels. The two branch channels are connected to an end of the main channel away from the sample channel. The two branch channels are disposed at two sides of the main channels respectively. The sample channel and the main channels of the plurality of divergent channels are substantially connected to each other in serial along a direction.

In an embodiment of the disclosure, the microfluidic chip further includes a plurality of collection grooves. The collection grooves are disposed in the substrate. The collection grooves are arranged along the direction. The two branch channels of one of the divergent channels are connected to one of the collection grooves.

In an embodiment of the disclosure, the two branches of the divergent channel closest to the sample channel are connected to one of the collection grooves farthest away from the sample channel.

In an embodiment of the disclosure, the microfluidic chip further includes a plurality of collection grooves. The collection grooves are disposed in the substrate. The collection grooves are located at the two sides of the main channels respectively. The branch channels of the divergent channels are connected to the collection grooves respectively.

In an embodiment of the disclosure, in at least one of the divergent channels, widths of the two branch channels are smaller than a width of the main channel.

In an embodiment of the disclosure, a width of one of the branch channels close to the sample channel is greater than a width of one of the branch channels away from the sample channel.

In an embodiment of the disclosure a width of one of the main channels close to the sample channel is greater than a width of one of the main channels away from the sample channel.

In an embodiment of the disclosure, widths of the main channels are substantially equal.

According to an embodiment of the disclosure, a sperm sorting method includes injecting buffer liquid into an upstream of a channel from two sides of the channel, such that two buffer layers are formed on two sidewalls of the channel respectively, and injecting semen into the upstream of the channel from middle of the channel, such that a semen layer is formed between the two buffer layers.

In an embodiment of the disclosure, the method further includes respectively dividing the two buffer layers and the semen layer at downstream of the channel, such that the two buffer layers and the semen layer flows to a plurality of collection grooves respectively, and collecting sperm from the collection grooves.

In an embodiment of the disclosure, the method further includes before injecting the buffer liquid and the semen into the channels, injecting hydrophilic liquid into the channel.

Accordingly, in the microfluidic chip and the sperm sorting method of the disclosure, the semen layer is sandwiched between the two buffer layers. In this way, active sperm will take the lead out of the semen layer and swim along one of the branch channels to the collection groove according to the biological characteristics, swimming by side, of the sperm themselves. On the other hand, non-active sperm flow along with the semen layer flow to another collection groove. In this way, it is possible to effectively sort the sperm with high activity and non-activity. In addition, the arrangement of the plurality of divergent channels and the sample channel in series can further sort out the activity levels of the sperm. As such, the user can select the appropriate sperm according to demands.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1A is a top view of a microfluidic chip according to an embodiment of the disclosure;

FIG. 1B is an enlarged view of a circle R1 in FIG. 1A;

FIG. 1C is an enlarged view of a circle R2 in FIG. 1A;

FIG. 2 is a top view of a microfluidic chip according to another embodiment of the disclosure, wherein there are two fluidic grooves;

FIG. 3 is a top view of a microfluidic chip according to another embodiment of the disclosure, wherein collection grooves are located at two sides of main channels;

FIG. 4 is a top view of a microfluidic chip according to another embodiment of the disclosure, wherein collection grooves and fluidic grooves are located at two sides of main channels; and

FIG. 5 is a flow chart of a sperm sorting method according to an embodiment of the disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

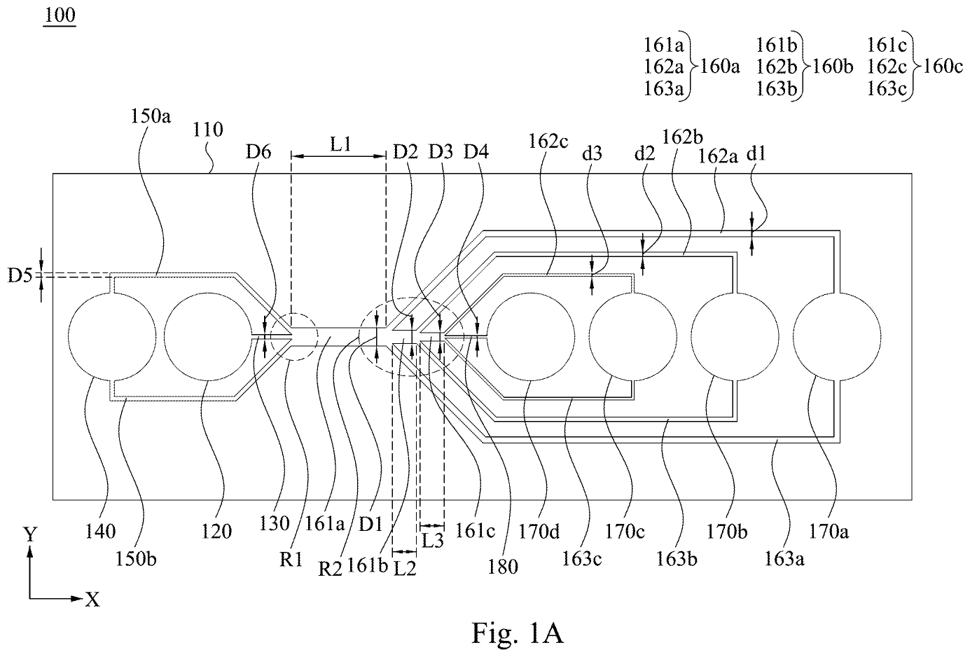

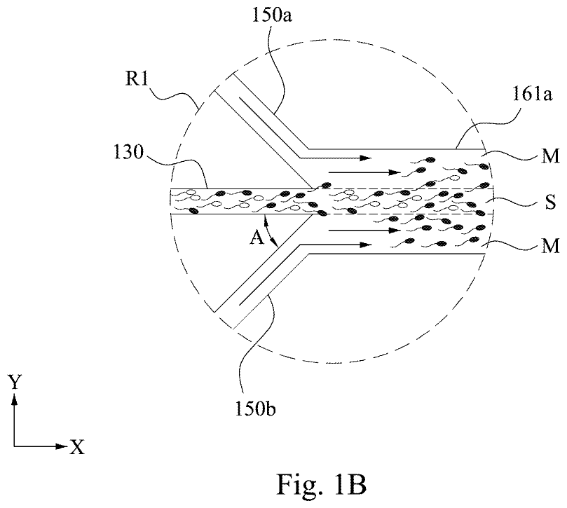

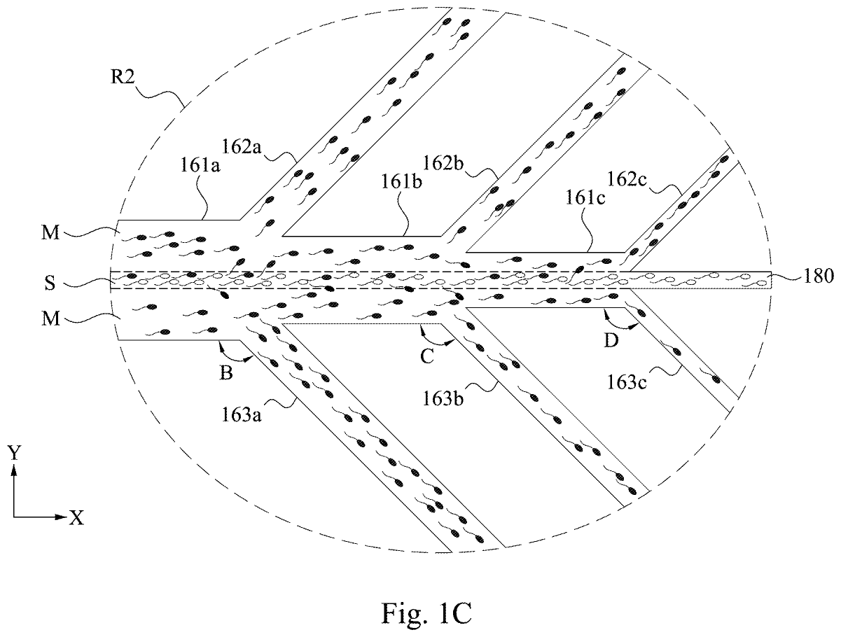

Reference is made to FIGS. 1A-1C. FIG. 1A is a top view of a microfluidic chip 100 according to an embodiment of the disclosure. FIG. 1B is an enlarged view of a circle R1 in FIG. 1A. FIG. 1C is an enlarged view of a circle R2 in FIG. 1A.

As shown in FIG. 1A, the microfluidic chip 100 includes a substrate 110, a sample groove 120, a sample channel 130, a fluidic groove 140, two fluidic channels 150a, 150b, three divergent channels 160a, 160b, and 160c, four collection grooves 170a, 170b, 170c, and 170d, and an output channel 180. The sample groove 120, the sample channel 130, the fluidic groove 140, the two fluidic channels 150a, 150b, the three divergent channels 160a, 160b, and 160c, the four collection grooves 170a, 170b, 170c, and 170d, and the output channel 180 are all disposed in the substrate 110. Specifically, the sample groove 120, the fluidic groove 140, and the four collection grooves 170a, 170b, 170c, and 170d are notches recessed from a surface of the substrate 110. The sample groove 120 is configured to inject sample fluid, for example, semen. The fluidic groove 140 is configured to inject buffer liquid. The collection grooves 170a, 170b, 170c, and 170d are configured to collect sperm, the semen and the buffer liquid. The sample channel 130, the fluidic channels 150a, 150b, the three divergent channels 160a, 160b, and 160c, and the output channel 180 are channels formed by recessing the surface of the substrate 110, or the channels embedded in the substrate 110 which allow liquid, such as the semen or the buffer liquid, to flow through. However, the disclosure should not be limited in this regard.

In some embodiments, the material of the substrate 110 can be acrylonitrile butadiene styrene (ABS), polypropylene (PP), polyvinyl chloride (PVC), polycarbonate (PC), polystyrene (PS), polyethylene (PE), polyamide (PA), and/or polymethyl methacrylate (PMMA), but the disclosure should not be limited in this regard.

In some embodiments, the buffer liquid can be phosphate buffered saline (PBS), balanced salt solution (BSS), medium, or other buffer liquid which is not susceptible to change the pH value by adding small amount of acid or base therein. The disclosure should not be limited in this regard.

In some embodiments, recessed depths of the sample groove 120, the fluidic groove 140, and the four collection grooves 170a, 170b, 170c, and 170d are in a range about 3000 μm˜5000 μm, but the disclosure should not be limited in this regard.

In some embodiments, recessed depths of the sample channel 130, the fluidic channels 150a, 150b, the three divergent channels 160a, 160b, and 160c, and the output channel 180 are in a range about 50 μm˜100 μm, but the disclosure should not be limited in this regard.

The sample groove 120 is connected to one end of the sample channel 130. The fluidic groove 140 is connected to two ends of the two fluidic channels 150a, 150b. The other end of the sample channel 130 is connected to the other two ends of the two fluidic channels 150a, 150b. The two fluidic channels 150a, 150b are located at two sides of the sample channel 130 respectively, such that the sample channel 130 is positioned between the two fluidic channels 150a, 150b. Two angles A (as shown in FIG. 1B, only one angle is exemplarily indicated in FIG. 1B) are formed between the sample channel 130 and the two fluidic channels 150a, 150b respectively. In some embodiments, the angles A are acute angles. For example, the angles A are formed in a range about 30° to 60°, but the disclosure is not limited in this regard.

With the configuration above, the semen is injected into the sample groove 120 and flows out from the sample channel 130. The buffer liquid is injected into the fluidic groove 140 and flows out from the fluidic channels 150a, 150b. When the buffer liquid and the semen converge, the buffer liquid and the semen form two buffer layers M and a semen layer S respectively, and the semen layer S is sandwiched between the two buffer layers M, as shown in FIG. 1B. As such, by the biological characteristics, swimming by side, of the sperm, the highly active sperm, as shown as solid sperm in FIG. 1B, will swim out from the semen layer S to the buffer layers M. The sperm with low activity or even non-activity, as shown as hollow sperm in FIG. 1B, will stay in the semen layer S, and flow as the semen flow in the semen layer S.

Continue to refer to FIG. 1A. The divergent channel 160a includes a main channel 161a and two branch channels 162a, 163a. One end of the main channel 161a is connected to the sample channel 130 and the two fluidic channels 150a, 150b. Further, the two fluidic channels 150a, 150b are positioned at two sides of the main channel 161a. Two ends of the two branch channels 162a, 163a are connected to the other end of the main channel 161a, that is, the end of the main channel 161a away from the sample channel 130. Similarly, the divergent channel 160b includes a main channel 161b and two branch channels 162b, 163b. The divergent channel 160c includes a main channel 161c and two branch channels 162c, 163c. One end of the main channel 161b is connected to the end of the main channel 161a away from the sample channel 130. The main channel 161b is positioned between the two branch channels 162b, 163b. Two ends of the two branch channels 162b, 163b are connected to the other end of the main channel 161b away from the main channel 161a. One end of the main channel 161c is connected to the end of the main channel 161b away from the main channel 161a. The main channel 161c is positioned between the two branch channels 162c, 163c. Two ends of the two branch channels 162c, 163c are connected to the other end of the main channel 161c away from the main channel 161b. One end of the output channel 180 is connected to the end of the main channel 161c away from the main channel 161b. The output channel 180 is positioned between the two branch channels 162c, 163c. In other words, the sample channel 130, the main channels 161a, 161b, and 161c, and the output channel 180 are substantially sequentially connected along a direction X.

Further, two angles B (as shown in FIG. 1C, only one angle is exemplarily indicated in FIG. 1C) are formed between the main channel 161a and the two branch channels 162a, 163a respectively. Two angles C (as shown in FIG. 1C, only one angle is exemplarily indicated in FIG. 1C) are formed between the main channel 161b and the two branch channels 162b, 163b respectively. Two angles D (as shown in FIG. 1C, only one angle is exemplarily indicated in FIG. 1C) are formed between the main channel 161c and the two branch channels 162c, 163c respectively. In some embodiments, the angles B are obtuse angles. For example, the angles B are formed in a range about 120° to 150°, but the disclosure is not limited in this regard. In some embodiments, the angles C are obtuse angles. For example, the angles C are formed in a range about 120° to 150°, but the disclosure is not limited in this regard. In some embodiments, the angles D are obtuse angles. For example, the angles D are formed in a range about 120° to 150°, but the disclosure is not limited in this regard.

A width D1 of the main channel 161a is greater than widths d1 of the two branch channels 162a, 163a. A width D2 of the main channel 161b is greater than widths d2 of the two branch channels 162b, 163b. A width D3 of the main channel 161c is greater than widths d3 of the two branch channels 162c, 163c. Among the three divergent channels 160a, 160b, and 160c, the width D1 of the main channel 161a is the biggest, the width D2 of the main channel 161b is second, and the width D3 of the main channel 161c is the smallest. In other words, the widths D1, D2, and D3 of the main channels 161a, 161b, and 161c gradually decrease from the divergent channel 160a which is close to the sample channel 130 to the divergent channel 160c which is away from the sample channel 130. In this way, the high active sperm are more likely to swim from the main channel 161a to the branch channels 162a, 163a, or from the main channel 161b to the branch channels 162b, 163b, or from the main channel 161c to the branch channels 162c, 163c to enhance the amount of the sperm in the collection grooves 170a, 170b, and 170c. Similarly, the widths d1 of the branch channels 162a, 163a are greater than the widths d2 of the branch channels 162b, 163b. The widths d2 of the branch channels 162b, 163b are greater than the widths d3 of the branch channels 162c, 163c.

Since the widths d1 of the branch channels 162a, 163a are greater than the widths d2 of the branch channels 162b, 163b, and the widths d2 of the branch channels 162b, 163b are greater than the widths d3 of the branch channels 162c, 163c, the flow rates in the branch channels 162a, 163a are the slowest among the branch channels 162a, 163a, 162b, 163b, 162c, and 163c under the same flow amount and pressure. As such, the sperm will have enough time to swim into the branch channels 162a, 163a. In this way, the chances of collecting viable sperm can be greatly enhanced.

Furthermore, the width D1 of the main channel 161a is greater than widths D5 of the two fluidic channels 150a, 150b and a width D6 of the sample channel 130. The widths D5 of the two fluidic channels 150a, 150b are greater than the width D6 of the sample channel 130. The width D3 of the main channel 161c is greater than a width D4 of the output channel 180.

In some embodiments, the width D1 of the main channel 161a is in a range about 400 μm˜800 μm. The width D2 of the main channel 161b is in a range about 350 μm˜750 μm. The width D3 of the main channel 161c is in a range about 300 μm˜700 μm. The widths d1 of the branch channels 162a, 163a are in a range about 300 μm˜500 μm. The widths d2 of the branch channels 162b, 163b are in a range about 200 μm˜400 μm. The widths d3 of the branch channels 162c, 163c are in a range about 100 μm˜300 μm. The width D4 of the output channel 180 is in a range about 100 μm˜300 μm. The widths D5 of the fluidic channels 150a, 150b are in a range about 300 μm˜500 μm. The width D6 of the sample channel 130 is in a range about 100 μm˜300 μm. However, the disclosure should not be limited in this regard.

The main channels 161a, 161b, and 161c have lengths L1, L2, and L3 respectively. In some embodiments, the length L1 of the main channel 161a is in a range about 3000 μm˜8000 μm. The length L2 of the main channel 161b is in a range about 1000 μm˜3000 μm. The length L3 of the main channel 161c is in a range about 1000 μm˜3000 μm. However, the disclosure should not be limited in this regard.

In another embodiment, the widths D1, D2, and D3 of the main channels 161a, 161b, and 161c are substantially equal. However, the disclosure should not be limited in this regard.

The collection groove 170a is connected to the other ends of the branch channels 162a, 163a. The collection grooves 170b is connected to the other ends of the branch channels 162b, 163b. The collection groove 170c is connected to the other ends of the branch channels 162c, 163c. The collection grooves 170d is connected to the other end of the output channel 180. The collection grooves 170d, 170c, 170b, and 170a are arranged sequentially along the direction X. The collection groove 170d is closest to the sample groove 120 among the collection grooves 170a, 170b, 170c, and 170d. The collection groove 170a is the farthest from the sample groove 120 among the collection grooves 170a, 170b, 170c, and 170d. Moreover, the collection groove 170a is connected to the two branch channels 162a, 163a which are closest to the sample channel 130 among the branch channels 162a, 163a, 162b, 163b, 162c, and 163c. The collection groove 170d is connected to the output channel 180 which is the farthest from the sample channel 130.

With the configuration above, as shown in FIG. 1C, the sperm with the highest activity take the lead to swim out from the sperm layer S, and then swim into the collection groove 170a along the branch channels 162a, 163a. The sperm that swim out of the sperm layer S after they passes through the divergent channel 160a can be defined as the sperm with the second activity. The sperm with second activity are able to swim along the branch channels 162b, 163b into the collection groove 170b. Similarly, the sperm that swim out of the sperm layer S after they passes through the divergent channels 160a, 160b can swim into the collection groove 170c along the branch channels 162c, 163c. The sperm with low activity and/or even non-activity cannot swim out of the sperm layer S on its own swimming power. Therefore, the sperm with low activity and/or even non-activity flow into the collection groove 170d with the semen flow in the semen layer S.

In addition, since the collection groove 170a is the farthest from the sample channel 130 among the collection grooves 170a, 170b, and 170c the sperm that can successfully swim into the collection groove 170a also represents that they have strong vitality. On the other hand, the collection groove 170c is the closet to the sample channel 130 among the collection grooves 170a, 170b, and 170c. Hence, the vitality of the sperm in the collection groove 170c is slightly worse comparing to the sperm in the collection grooves 170a, 170b. In this way, the microfluidic chip 100 of the present disclosure can not only screen the sperm with high activity and the low activity out, but also classify the activity degree of the sperm by the different distances between the divergent channels 160a, 160b, and 160c and the collection grooves 170a, 170b, and 170c to screen the sperm with best quality for insemination.

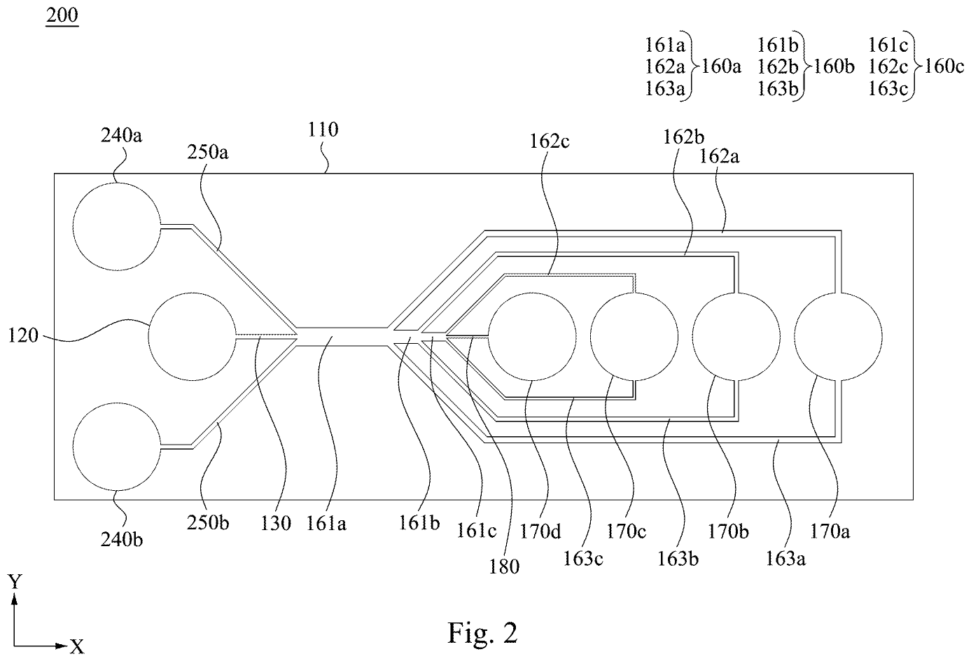

Reference is made to FIG. 2. FIG. 2 is a top view of a microfluidic chip 200 according to another embodiment of the disclosure, wherein there are two fluidic grooves 240a, 240b. As shown in FIG. 2, in the embodiment, the microfluidic chip 200 includes the substrate 110, the sample groove 120, the sample channel 130, the two fluidic grooves 240a, 240b, the two fluidic channels 250a, 250b, the three divergent channels 160a, 160b, and 160c, the four collection grooves 170a, 170b, 170c, and 170d, and the output channel 180. The substrate 110, the sample groove 120, the sample channel 130, the three divergent channels 160a, 160b, and 160c, the four collection grooves 170a, 170b, 170c, and 170d, and the output channel 180 of the present embodiment are similar to those of the embodiment in FIG. 1A, so the introductions of these components can refer to the previous descriptions and therefore are not repeated here to avoid duplicity. Compared with the embodiment of FIG. 1A, the microfluidic chip 200 of the present embodiment has the two fluidic grooves 240a, 240b. The two fluidic grooves 240a, 240b are located at the two sides of the sample channel 130 respectively. Further, the two fluidic grooves 240a, 240b are connected to two ends of the fluidic channels 250a, 250b respectively.

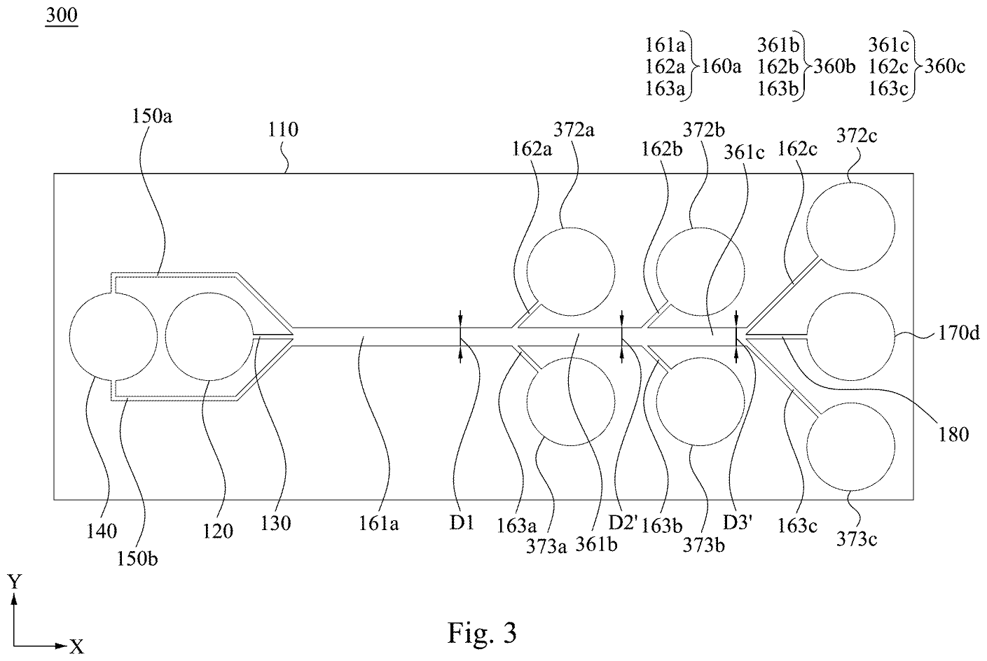

Reference is made to FIG. 3. FIG. 3 is a top view of a microfluidic chip 300 according to another embodiment of the disclosure, wherein collection grooves 372a, 372b, and 372c and collection grooves 373a, 373b, and 373c are located at the two sides of the main channels 161a, 361b, and 361c. As shown in FIG. 3, in the embodiment, the microfluidic chip 300 includes the substrate 110, the sample groove 120, the sample channel 130, the fluidic groove 140, the two fluidic channels 150a, 150b, the three divergent channels 160a, 360b, and 360c, the seven collection grooves 372a, 373a, 372b, 373b, 372c, 373c, and 170d, and the output channel 180. The substrate 110, the sample groove 120, the sample channel 130, the fluidic groove 140, the two fluidic channels 150a, 150b, the divergent channel 160a, the collection groove 170d and the output channel 180 of the present embodiment are similar to those of the embodiment in FIG. 1A, so the introductions of these components can refer to the previous descriptions and therefore are not repeated here to avoid duplicity. Compared with the embodiment of FIG. 1A, each of the branch channels 162a, 163a, 162b, 163b, 162c, and 163c is connected to the corresponding collection grooves 372a, 373a, 372b, 373b, 372c, and 373c respectively. Specifically, the branch channel 162a is connected to the collection groove 372a. The branch channel 163a is connected to the collection groove 373a. The branch channel 162b is connected to the collection groove 372b. The branch channel 163b is connected to the collection groove 373b. The branch channel 162c is connected to the collection groove 372c. The branch channel 163c is connected to the collection groove 373c. Besides, the collection grooves 372a, 372b, and 372c are all located at one side of the main channels 161a, 361b, and 361c. The collection grooves 373a, 373b, and 373c are all located at the other side of the main channels 161a, 361b, and 361c.

Further, in the embodiment, a width D2′ of the main channel 361b is substantially equal to the width D1 of the main channel 161a. Likely, a width D3′ of the main channel 361c is substantially equal to the width D1 of the main channel 161a. That is, the main channels 161a, 361b, and 361c have substantially the same width.

In another embodiment, the width D2′ of the main channel 361b is smaller than the width D1 of the main channel 161a. The width D3′ of the main channel 361c is smaller than the width D2′ of the main channel 361b. In other words, the widths D1, D2′, and D3′ of the main channels 161a, 361b, and 361c gradually decrease from the divergent channel 160a which is close to the sample channel 130 to the divergent channel 360c which is away from the sample channel 130. As such, the active sperm are more likely to swim into the branch channels 162a, 163a from the main channel 161a, or to swim into the branch channels 162b, 163b from the main channel 361b, or to swim into the branch channels 162c, 163c from the main channel 361c so as to enhance the amount of the sperm in the collection grooves 372a, 373a, 372b, 373b, 372c, and 373c. However, the disclosure should not be limited in this regard.

As the configuration shown in FIG. 3, after the sperm swim out of the sperm layer S, the sperm can quickly reach the collection grooves 372a, 373a, 372b, 373b, 372c, and 373c, to avoid the waste of the physical strength of the sperm. In addition, the microfluidic chip 300 can also classify the activity levels of the sperm by the different distances between the branch channels 162a, 163a, 162b, 163b, 162c, and 163c.

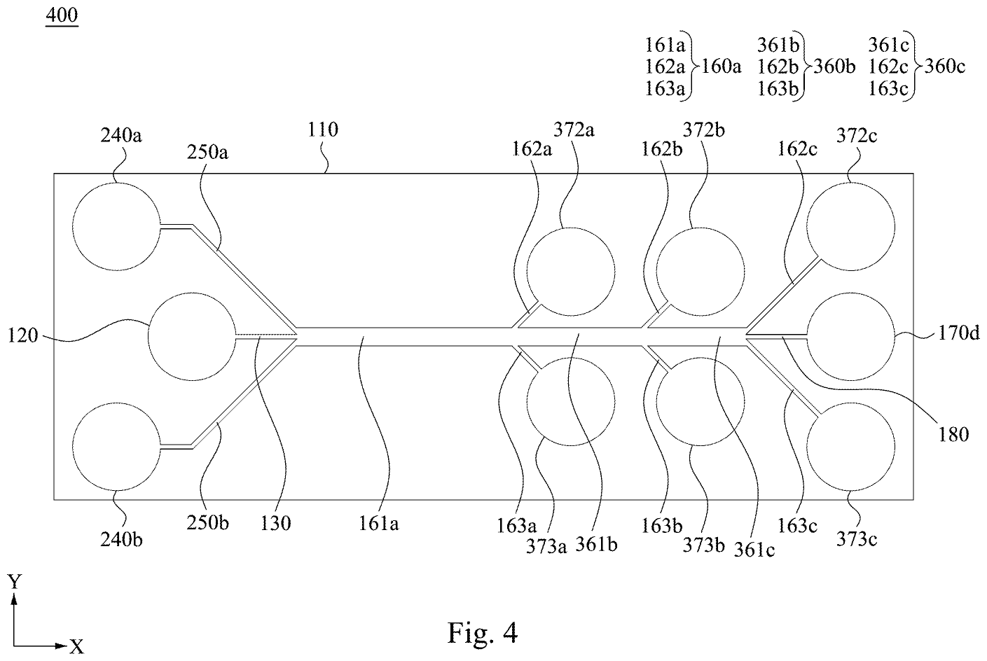

Reference is made to FIG. 4. FIG. 4 is a top view of a microfluidic chip 400 according to another embodiment of the disclosure, wherein the collection grooves 372a, 373a, 372b, 373b, 372c, and 373c and the fluidic grooves 240a, 240b are located at the two sides of the main channels 161a, 361b, and 361c. As shown in FIG. 4, in the embodiment, the microfluidic chip 400 includes the substrate 110, the sample groove 120, the sample channel 130, the two fluidic grooves 240a, 240b, the two fluidic channels 250a, 250b, the three divergent channels 160a, 360b, and 360c, the seven collection grooves 372a, 373a, 372b, 373b, 372c, 373c, and 170d, and the output channel 180. The substrate 110, the sample groove 120, the sample channel 130, the divergent channel 160a, the collection groove 170d, and the output channel 180 of the present embodiment are similar to those of the embodiment in FIG. 1A, so the introductions of these components can refer to the previous descriptions and therefore are not repeated here to avoid duplicity. The two fluidic grooves 240a, 240b and the fluidic channels 250a, 250b of the present embodiment are similar to those of the embodiment in FIG. 2, the divergent channels 360b, 360c, and the collections grooves 372a, 373a, 372b, 373b, 372c, and 373c are similar to those of the embodiment in FIG. 3, so the introductions of these components can refer to the previous descriptions and therefore are not repeated here to avoid duplicity. Specifically, the microfluidic chip 400 is a combination of the embodiments shown in FIGS. 2 and 3. In other words, the fluidic grooves 240a, 240b are located at the two sides of the main channels 161a, 361b, and 361c. The collection grooves 372a, 372b, and 372c and the collection grooves 373a, 373b, and 373c are located at the two sides of the main channels 161a, 361b, and 361c respectively.

In some embodiments, the number, shape, location, and size of the divergent channels, the fluidic grooves, and the collection grooves are adjustable according to the actual implementation. The disclosure should not be limited in this regard. For example, the microfluidic chip may have four or more divergent channels serially connected between the sample channel and the output channel. Correspondingly, the number of the collection groove is five or more, and the collection grooves are respectively connected to two branch channels of each divergent channel and the output channel. Alternatively, in some embodiments, the number of collection groove is nine or more, and each collection groove is connected to the corresponding branch channel and the output channel. However, the disclosure should not be limited in this regard.

In some embodiments, the shape of the collection grooves may be any shape, such as a rectangle, a polygon, and so on. The disclosure should not be limited in this regard.

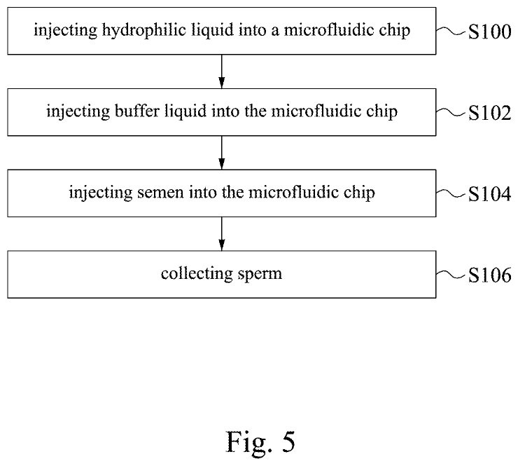

Reference is made to FIG. 5. FIG. 5 is a flow chart of a sperm sorting method according to an embodiment of the disclosure. As shown in FIG. 5, in the embodiment, the sperm sorting method includes steps S100 to S106. The sperm sorting method of the present embodiment will be exemplarily described below together with the microfluidic chip 100 in FIG. 1A. However, the sperm sorting method can also be applied to the microfluidic chips 200, 300, or 400 in FIGS. 2 to 4. The disclosure should not be limited in this regard.

In step S100, injecting hydrophilic liquid into the microfluidic chip 100. In the embodiment, before injecting the semen and the buffer liquid into the microfluidic chip 100, the hydrophilic liquid is injected into the fluidic groove 140 and the sample groove 120 of the microfluidic chip 100 to let the hydrophilic liquid flows through the two fluidic channels 150a, 150b, the sample channel 130, the divergent channels 160a, 160b, and 160c, the output channel 180, and the collection grooves 170a, 170b, 170c, and 170d. Thereby, the hydrophilicity of the fluidic groove 140, the sample groove 120, the fluidic channels 150a, 150b, the sample channel 130, the divergent channels 160a, 160b, and 160c, the output channel 180, and the collection grooves 170a, 170b, 170c, and 170d can be enhanced, such that the semen and the buffer liquid can smoothly flow in the microfluidic chip 100 and to prevent the sperm from blocking the channels. Besides, the hydrophilic liquid can remove the contamination from the fluidic groove 140, the sample groove 120, the fluidic channels 150a, 150b, the sample channel 130, the divergent channels 160a, 160b, and 160c, the output channel 180, and/or the collection grooves 170a, 170b, 170c, and 170d to avoid the contamination pollute the sample when collecting the sperm.

After ensuring the hydrophilic liquid has thoroughly flowed through the fluidic groove 140, the sample groove 120, the fluidic channels 150a, 150b, the sample channel 130, the divergent channels 160a, 160b, and 160c, the output channel 180, and the collection grooves 170a, 170b, 170c, and 170d, removing the hydrophilic liquid from the microfluidic chip 100.

In some embodiments, the hydrophilic liquid can be bovine serum albumin (BSA), polyethylene glycol (PEG), and so on, but the disclosure should not be limited in this regard.

Next, in step S102, injecting the buffer liquid into the microfluidic chip 100. In the embodiment, the buffer liquid, such as PBS, BBS, medium, is injected into the fluidic groove 140 of the microfluidic chip 100, such that the buffer liquid is injected into the two fluidic channels 150a, 150b and the divergent channels 160a, 160b, and 160c from the fluidic groove 140.

In step S104, injecting the semen into the microfluidic chip 100. In the embodiment, the sample, i.e., the semen, is injected into the sample groove 120 of the microfluidic chip 100, such that the semen is injected into the sample channel 130 and the divergent channels 160a, 160b, and 160c from the sample groove 120.

Since the flow rates of the semen and the buffer liquid are slow, when the semen and the buffer liquid converge, the buffer liquid and the semen flow in a layered manner, and a laminar flow is formed in the main channels 161a, 1601b, and 161c. In other word, as described above, the buffer liquid and the semen will form the buffer layers M and the semen layer S respectively. Further, since the sample channel 130 is positioned between the two fluidic channels 150a, 150b, the semen layer S is formed between the two buffer layers M, as shown in FIG. 1B.

Because the sperm have the biological characteristics of “swimming by sides,” the sperm having high activity in the semen layer S will swim to the buffer layers M on both sides. The ends of the main channels 161a, 161b, and 161c away from the sample channel 130, i.e., the downstream of the semen layer S and the buffer layers M, are connected to the branch channels 162a, 163a, 162b, 163b, 162c, and 163c respectively. Thereby, the branch channels 162a, 163a, 162b, 163b, 162c, and 163c divert the semen layer S and the buffer layers M, such that the sperm swimming in the buffer layers M flow into the branch channels 162a, 163a, 162b, 163b, 162c, and 163c with the buffer liquid flowing in the buffer layers M, as shown in FIG. 1C.

Moreover, as the branch channels 162a, 163a are closet to the sample channel 130, the sperm with greatest activity swim out of the semen layer S first, and flow into the branch channels 162a, 163a and the collection groove 170a with the buffer liquid. Similarly, as the activity levels of the sperm are different, the time for the sperm to swim out of the semen layer S is different. Depending on the time that the sperm swimming out, the sperm will flow through the branch channels 162b, 163b to the collection groove 170b or through the branch channels 162c, 163c to the collection groove 170c. The sperm with low activity or even non-activity, will stay in the semen layer S, and flow into the output channel 180 and the collection groove 170d with the semen flow in the semen layer S.

Finally, in step S106, collecting the sperm from the collection grooves 170a, 170b, and 170c respectively to obtain the sperm with different activity degrees. Among the collection grooves 170a, 170b, and 170c, the motility of sperm collected from the collection groove 170a is the strongest. The motility of sperm collected from the collection groove 170b is second. The motility of sperm collected from the collection groove 170c is slightly inferior.

In some embodiments, step S100 can be optionally omitted. That is, the sperm sorting method can be start directly from step S102.

With the sperm sorting method described above using the microfluidic chip 100/200/300/400 of the present disclosure, the medical personnel can quickly and effectively sort out the sperm with different activity levels. In this way, the time and the physical strength of the medical personnel can be greatly saved. For patients troubled with infertility, the successful rate of assisted reproductive technology can also be improved.

According to the foregoing recitations of the embodiments of the disclosure, it can be seen that in the microfluidic chip and the sperm sorting method of the disclosure, the semen layer is sandwiched between the two buffer layers. In this way, active sperm will take the lead out of the semen layer and swim along one of the branch channels to the collection groove according to the biological characteristics, swimming by sides, of the sperm. On the other hand, non-active sperm in the semen layer flow to another collection groove. In this way, it is possible to effectively sort the sperm with high activity and non-activity. In addition, the connection of the plurality of divergent channels and the sample channel in series can further sort out the activity levels of the sperm. As such, the user can select the appropriate sperm according to demands.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A microfluidic chip for sorting sperm, comprising:
a substrate;
a sample channel disposed in the substrate; and
a plurality of divergent channels disposed in the substrate, each of the divergent channels comprising:
a main channel; and
two branch channels connected to an end of the main channel away from the sample channel and disposed at two sides of the main channels respectively,
wherein the sample channel and the main channels of the plurality of divergent channels are substantially connected to each other in serial along a direction.

2. The microfluidic chip of claim 1, further comprising a plurality of collection groove disposed in the substrate, wherein the collection grooves are arranged along the direction, and the two branch channels of one of the divergent channels are connected to one of the collection grooves.

3. The microfluidic chip of claim 2, wherein the two branches of the divergent channel closest to the sample channel are connected to one of the collection grooves farthest away from the sample channel.

4. The microfluidic chip of claim 1, further comprising a plurality of collection grooves disposed in the substrate, wherein the collection grooves are located at the two sides of the main channels respectively, and the branch channels of the divergent channels are connected to the collection grooves respectively.

5. The microfluidic chip of claim 1, wherein in at least one of the divergent channels, widths of the two branch channels are smaller than a width of the main channel.

6. The microfluidic chip of claim 1, wherein a width of one of the branch channels close to the sample channel is greater than a width of one of the branch channels away from the sample channel.

7. The microfluidic chip of claim 1, wherein a width of one of the main channels close to the sample channel is greater than a width of one of the main channels away from the sample channel.

8. The microfluidic chip of claim 1, wherein widths of the main channels are substantially equal.

9. A sperm sorting method, comprising:
injecting buffer liquid into an upstream of a channel from two sides of the channel, such that two buffer layers are formed on two sidewalls of the channel respectively; and
injecting semen into the upstream of the channel from middle of the channel, such that a semen layer is formed between the two buffer layers.

10. The method of claim 9, further comprising:
respectively dividing the two buffer layers and the semen layer at downstream of the channel, such that the two buffer layers and the semen layer flows to a plurality of collection grooves respectively; and
collecting sperm from the collection grooves.

11. The method of claim 9, further comprising:
before injecting the buffer liquid and the semen into the channel, injecting hydrophilic liquid into the channel.
